(19) United States
(12) Patent Application Publication
(10) Pub. No.: US 2022/0392120 A1
(43) Pub. Date: Dec. 8, 2022

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventor: MAKOTO DANIEL TOKUNAGA, TOKYO (JP)

(21) Appl. No.: 17/757,506

(22) PCT Filed: Dec. 11, 2020
(86) PCT No.: PCT/JP2020/046342

§ 371 Date: Jun. 16, 2022

(30) Foreign Application Priority Data
Dec. 25, 2019 (JP) 2019-235264

(51) Int. Cl. G06T 11/00; H04N 5/232; G06Q 30/06

(52) U.S. Cl. CPC G06T 11/001; H04N 5/23222; G06Q 30/0631

(57) ABSTRACT

An information processing apparatus (100) according to the present disclosure includes: a proposal unit (165) that proposes, to a user, imaging of another real object that complements color information used for correcting a color gamut of a virtual object displayed to be superimposed on a predetermined real object; and a display control unit (166) that corrects the color gamut of the virtual object based on color information acquired by imaging of the another real object presented by the user.

### FIELD

The present invention relates to an information processing apparatus, an information processing method, and an information processing program.

### BACKGROUND

There are known technologies related to Augmented Reality that augments a real world by adding digital information to information regarding a real space visible through a camera. For example, proposed is a technology in which a real object existing in a user's real environment is imaged, and a color gamut of a virtual object displayed to be superimposed on the real object is corrected by the augmented reality technology based on color information regarding the imaged real object.

### CITATION LIST

### Non Patent Literature

Non Patent Literature 1: Thomas Oskam and three others, “Fast and Stable Color Balancing for Images and Augmented Reality”, [Online], March 2019, [searched on Nov. 14, 2019], Internet <URL:https://studios.disneyresearch.com/wp-content/uploads/2019/03/Fast-and-Stable-Color-Balancing-for-Images-and-Augmented-Reality-1.pdf>

### SUMMARY

### Technical Problem

However, with the above known technology, it is difficult to always ensure improvement of convenience regarding color correction of a virtual object. For example, the above known technology merely performs imaging of a real object existing in user's real environment and correction of a color gamut of a virtual object displayed to be superimposed on the real object by using the augmented reality technology based on color information regarding the imaged real object, and it is difficult to always ensure improvement of convenience regarding color correction of the virtual object.

In view of this, the present disclosure proposes an information processing apparatus, an information processing method, and an information processing program capable of improving convenience regarding color correction of a virtual object.

### Solution to Problem

To solve the above problem, an information processing apparatus according to the present disclosure includes: a proposal unit that proposes, to a user, imaging of another real object that complements color information used for correcting a color gamut of a virtual object displayed to be superimposed on a predetermined real object; and a display control unit that corrects the color gamut of the virtual object based on color information acquired by imaging of the another real object presented by the user.

### BRIEF DESCRIPTION OF DRAWINGS

FIG. 1 is a diagram illustrating an example of information processing according to an embodiment of the present disclosure.

FIG. 2 is a diagram for describing a relationship between estimation of parameters for color gamut correction and an observation error (case where no observation error is included).

FIG. 3 is a diagram for describing a relationship between estimation of parameters for color gamut correction and an observation error (case where an observation error is included).

FIG. 4 is a diagram for describing a relationship between estimation of parameters for color gamut correction and an observation error (case where an observation error is included).

FIG. 5 is a diagram illustrating a configuration example of an information processing system according to the embodiment of the present disclosure.

FIG. 6 is a diagram illustrating a configuration example of a terminal device according to the embodiment of the present disclosure.

FIG. 7 is a diagram illustrating a configuration example of a server device according to the embodiment of the present disclosure.

FIG. 8 is a diagram illustrating an example of a product information storage unit according to the embodiment of the present disclosure.

FIG. 9 is a diagram illustrating an example of a user information storage unit according to the embodiment of the present disclosure.

FIG. 10 is a diagram illustrating an example of color information complement necessity determination processing according to the embodiment of the present disclosure.

FIG. 11 is a diagram illustrating an example of color information complement necessity determination processing according to the embodiment of the present disclosure.

FIG. 12 is a flowchart illustrating an information processing procedure according to the embodiment of the present disclosure.

FIG. 13 is a sequence diagram illustrating an information processing procedure according to the embodiment of the present disclosure.

FIG. 14 is a view illustrating an example of information processing according to a modification of the present disclosure.

FIG. 15 is a hardware configuration diagram illustrating an example of a computer that implements functions of an information processing apparatus.

### DESCRIPTION OF EMBODIMENTS

Embodiments of the present disclosure will be described below in detail with reference to the drawings. In each of the following embodiments, the same parts are denoted by the same reference numerals, and a repetitive description thereof will be omitted.

The present disclosure will be described in the following order.
1. Embodiments
1-1. Overview
1-2. Relationship between estimation of parameters for color gamut correction and observation error
1-3. Configuration of information processing system
1-4. Configuration of terminal device
1-5. Configuration of server device
1-6. Flow diagram of information processing
1-7. Sequence diagram of information processing
1-8. Modification according to embodiment
1-8-1. Combination of color correction marker and superimposition marker
1-8-2. Color sample for box of product
1-8-3. Proposal of object based on captured image
1-8-4. Method of determining object proposal priority
2. Other embodiments
3. Effects according to present disclosure
4. Hardware configuration

### 1. Embodiments

### 1-1. Overview

There is a known technology of displaying a virtual object image to be superimposed on an image obtained by capturing an object existing in a real space (real object) by using an augmented reality technology. For example, there is known a technology of displaying an image of a product (virtual object) a user of electronic commerce desires to purchase to be superimposed on a captured image of an object existing in a real environment (real object) of the user. In addition, there is also a known technology of adjusting a color tone of a virtual object according to a real environment when an image of the virtual object is displayed so as to be superimposed on the captured image of the real object in this manner.

For example, by acquiring camera setting information and using a known calibration color chart (also referred to as a color sample), the color tone of the virtual object is adjusted according to the real environment. However, acquisition of the camera setting information cannot be performed in many of cameras for general consumers. In addition, in order to correct the color of the light source, it is necessary to image a physically special color chart.

To handle this, Non Patent Literature 1 described above proposes a technology of imaging a real object existing in a user's real environment without using a special color chart and correcting the color gamut of the virtual object displayed to be superimposed on the real object based on color information regarding the imaged real object. The technology described in Non Patent Literature 1 enables color correction under augmented reality without acquiring the camera setting information or depending on a calibration object such as a color chart. However, in the technology described in Non Patent Literature 1, the accuracy of color correction depends on color information regarding the imaged real object. This has caused a problem that an error due to the color correction is likely to increase in attempt of reproducing, by correction, a color that does not exist in the captured real object or a completely different color.

In view of this, a terminal device 100 according to an embodiment of the present disclosure proposes, to the user, imaging of another real object that complements the color information used for correcting a color gamut of a virtual object displayed to be superimposed on a predetermined real object. Furthermore, the terminal device 100 corrects the color gamut of the virtual object based on color information acquired by imaging of another real object presented by the user. In this manner, in a case where the color information necessary for expressing the color of the virtual object is insufficient, the terminal device 100 proposes, to the user, observation of another real object that complements the insufficient color information, and corrects the color gamut of the virtual object based on the color information regarding the another real object. With this correction, the terminal device 100 can more easily correct the color gamut of the virtual object by using an object near the user as the color sample. This makes it possible for the terminal device 100 to improve convenience regarding color correction of the virtual object.

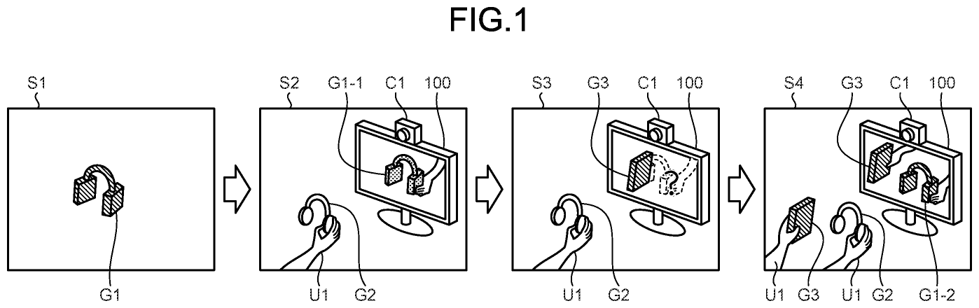

Hereinafter, an overview of information processing according to the embodiment of the present disclosure will be described with reference to FIG. 1. FIG. 1 is a diagram illustrating an example of information processing according to the embodiment of the present disclosure. In the example illustrated in FIG. 1, a user U1 of an electronic commerce service is interested in purchasing a red headphone (hereinafter, referred to as a product G1) which is a new-model product. An information processing system 1 uses a real object, which is an old-model black headphone (hereinafter, referred to as a product G2) purchased by the user U1 in the past, as a marker for display by augmented reality, and superimposes a virtual object (product G1) on the real object (product G2) being a marker for display by augmented reality. Hereinafter, the product G2 may be appropriately referred to as a “marker”.

First, the user U1 selects the virtual object (product G1) to be displayed by augmented reality. The terminal device 100 receives selection of the virtual object (product G1) from the user U1 (step S1). In addition, the user U1 images the real object (product G2) used as a marker when superimposing a virtual object by a camera C1 of the terminal device 100.

The terminal device 100 acquires an image of the real object (product G2) captured by the camera C1. Subsequently, based on the acquired image of the real object (product G2), the terminal device 100 recognizes the real object (product G2) and estimates the position and posture of the real object (product G2). After estimating the position and posture of the real object (product G2), the terminal device 100 displays an image G1-1 in which the virtual object (product G1) is superimposed on the real object (product G2) by augmented reality (step S2).

Furthermore, the terminal device 100 acquires a sample of the color under the real environment from the real object (product G2) designated as a marker when superimposing the virtual object. Specifically, the terminal device 100 acquires a sample of the color of the real object (product G2) under the real environment based on the acquired image of the real object G2.

Subsequently, based on the sample of the color of the real object (product G2) under the real environment, the terminal device 100 estimates a parameter for color gamut correction of the camera C1 (hereinafter, also simply referred to as a parameter) and then corrects the color gamut of the virtual object (product G1). At this time, the terminal device 100 determines whether there is sufficient color information necessary for expressing the color of the virtual object (product G1). Here, the terminal device 100 compares the color information regarding the virtual object (product G1) with the color information regarding the real object (product G2), and determines that the color information expressing the color of the virtual object (product G1) is insufficient since the colors of the virtual object (product G1) and the real object (product G2) are significantly different from each other. Note that details of the determination processing regarding the sufficiency of color information will be described below.

When having determined that the color information expressing the color of the virtual object (product G1) is insufficient, the terminal device 100 requests a server device 200 to determine whether there is information regarding another real object (different from the product G2) that complements the insufficient color information. The server device 200 receives a determination request of the information from the terminal device 100. When having received the determination request of the information, the server device 200 acquires information regarding the product purchased in the past by the user U1 based on the product purchase history of the user U1. Subsequently, the server device 200 selects a product G3 as another real object that can complement the insufficient color information from among the products purchased by the user U1 in the past. Specifically, the product G3 is a red smartphone. After having selected the another real object (product G3) that can complement the insufficient color information, the server device 200 transmits information regarding the selected another real object (product G3) to the terminal device 100. The terminal device 100 acquires information related to the another real object (product G3) from the server device 200. When having acquired information regarding the another real object (product G3), the terminal device 100 proposes, to the user U1, to additionally image the another real object (product G3) (step S3).

In response to the proposal from the terminal device 100, the user U1 images the another real object (product G3) in addition to the real object (product G2) by using the camera C1 of the terminal device 100. The terminal device 100 acquires an image of the another real object (product G3) captured by the camera C1. Subsequently, based on the acquired image of the another real object (product G3), the terminal device 100 recognizes the another real object (product G3) and estimates the position and posture of the another real object (product G3). Furthermore, based on the acquired image of the another real object (product G3), the terminal device 100 acquires a sample of the color of the another real object (product G3) under the real environment.

Subsequently, the terminal device 100 corrects the color gamut of the virtual object (product G1) based on the sample of the color of the another real object (product G3) under the real environment. Details of the processing of correcting the color gamut of the virtual object will be described below.

Subsequently, based on the color gamut of the virtual object (product G1) after the correction, the terminal device 100 corrects the color of the virtual object (product G1). Subsequently, the terminal device 100 displays an image G1-2 in which the virtual object (product G1) after the color correction is superimposed on the real object (product G2) being a marker (step S4).

As described above, the terminal device 100 proposes, to the user, imaging of another real object that complements the color information used for correcting a color gamut of a virtual object displayed to be superimposed on a predetermined real object. Furthermore, the terminal device 100 corrects the color gamut of the virtual object based on color information acquired by imaging of another real object presented by the user. In this manner, in a case where the color information for expressing the color of the virtual object is insufficient, the terminal device 100 proposes, to the user, imaging of another real object that can complement insufficient color information, and corrects the color gamut of the virtual object based on the color information regarding the another real object. With this correction, the terminal device 100 can more easily correct the color gamut of the virtual object by using a real object near the user as a color sample. This makes it possible for the terminal device 100 to improve convenience regarding color correction of the virtual object.

### 1-2. Relationship Between Estimation of Parameters for color gamut correction and observation error

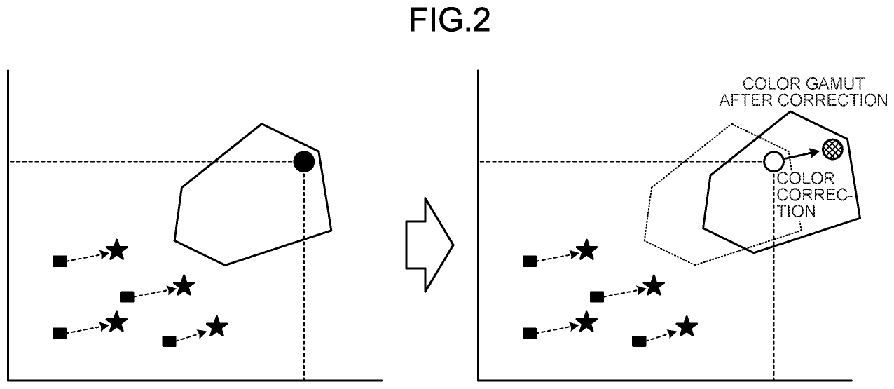

Next, a relationship between estimation of parameters for color gamut correction and an observation error will be described with reference to FIGS. 2 to 4. Here, the estimation of parameters for color gamut correction refers to estimation of a parameter when the information processing system 1 corrects the color gamut of the virtual object according to the real environment. In addition, the observation refers to acquisition, by the information processing system 1, of a sample of a color of a real object under the real environment from an image of a real object designated as a marker when superimposing a virtual object.

Before describing the relationship between estimation of parameters for color gamut correction and an observation error, a color value, a color space, and a color gamut will be described. The color value indicates a numerical value representing a color. Among several indexes representing color values, the embodiment of the present disclosure uses a color value CIE Lab, which is a commonly used index. CIE Lab is also described as L*a*b* in the sense of Lab defined by Commission Internationale de l'Eclairage (CIE) representing International Commission on Illumination. “L*” in L*a*b* represents lightness (light or dark). In addition, “a*” in L*a*b* represents the chromaticity, or the intensity of color tone, in green-red components. In addition, “b*” in L*a*b* represents the chromaticity, or the intensity of color tone, in blue-yellow components. These three values are independent indexes, and thus can be expressed in a three-dimensional orthogonal coordinate system using three coordinate axes orthogonal to each other. This is referred to as a L*a*b* color space (hereinafter, also referred to as a color space.). The color value is indicated by coordinates of a point in the color space. The color gamut refers to a portion of a color space. In other words, the color gamut indicates a range (region) of a color value in the color space.

Next, estimation of a parameter for color gamut correction will be described. For example, there is a method of estimating a parameter for color gamut correction using the following formula.

$$v ( e ) = \frac{1}{{ΣΦ}_{i} ( e )} {\sum }_{i} {Φ}_{i} ( e ) {w}_{i}$$

In the above formula, (v) represents a correction amount in an input color (e), and (4)) is a function that controls the correction amount for each observation sample color (i). By performing weighted (w) averaging on these samples, the final correction amount is calculated. However, as can be seen from this equation, since the correction amount heavily depends on the sample, an occurrence of an error in these observation samples would cause propagation of the error to the final estimation of color correction. In addition, the farther the color to be corrected is from the observation sample, the larger the error will be. This point will be described in detail below with reference to FIGS. 2 to 4.

In addition, there is a method of estimating a parameter for color gamut correction using the following formula.

$$[ \begin{matrix}{R}_{corrected} \\ {G}_{corrected} \\ {B}_{corrected}\end{matrix} ] = [ \begin{matrix}{Γ}_{RR} & {Γ}_{RG} & {Γ}_{RB} \\ {Γ}_{GR} & {Γ}_{GG} & {Γ}_{GB} \\ {Γ}_{BR} & {Γ}_{BG} & {Γ}_{BB}\end{matrix} ] [ \begin{matrix}{R}_{original} \\ {G}_{original} \\ {B}_{original}\end{matrix} ]$$

In the above equation, the color correction is expressed by a correction matrix. The correction matrix is found so as to obtain the minimum value of a difference between the sampled color and the known value. When this matrix is found, there is a high possibility that the non-sampled region is greatly shifted due to the bias with respect to the sample color.

As described above, in a case where the color to be expressed does not match the color sample of the observation, there is a high possibility of occurrence of a failure in even expressing the color. Therefore, in the calibration using the existing color chart, the color samples for correction have as wide variety of types as possible so as not to fail in expression. Therefore, a special chart is required.

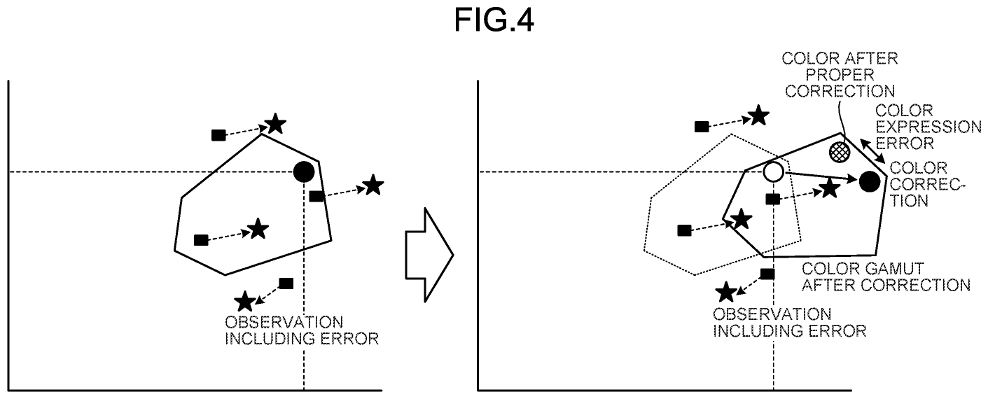

Returning to the description of FIGS. 2 and 4. In FIGS. 2 to 4, the L*a*b* color space is schematically illustrated by a two-dimensional space. Each point in the L*a*b* color space illustrated in FIGS. 2 to 4 indicates a color corresponding to the color value of each point. A square (filled square mark) in FIGS. 2 to 4 indicates a sample of an original color of a real object (corresponding to the product G2 illustrated in FIG. 1). Here, the original color refers to color information regarding a real object registered in a database (for example, a product information storage unit 221 to be described below) of the information processing system 1. In addition, a star (filled star mark) indicates a sample of the color of the real object acquired under the real environment. In addition, a dotted arrow indicates a correspondence between the sample of the original color of the real object and the sample of the color of the real object acquired under the real environment. Furthermore, a solid frame on the left side of FIGS. 2 to 4 indicates the color gamut of the virtual object before correction (corresponding to the product G1 in FIG. 1). A dotted frame on the right side of FIGS. 2 to 4 indicates the color gamut of the virtual object before correction. Furthermore, a solid frame on the right side of FIGS. 2 to 4 indicates the color gamut of the virtual object after correction.

Next, the relationship between estimation of parameters for color gamut correction and the observation error when no observation error is included will be described with reference to FIG. 2. FIG. 2 is a diagram for describing a relationship between estimation of parameters for color gamut correction and an observation error (case where no observation error is included). The example illustrated in FIG. 2 illustrates a case where a sample (filled star mark) of a color of a real object under the real environment is correctly acquired by the information processing system 1 (case where there is no observation error). For example, in the case of FIG. 2 with no observation error, the direction and the size of each vector indicated by an arrow of each dotted line from each sample (filled square mark) of the original color of the real object toward each sample (filled star mark) of the color of the real object under the real environment are substantially the same.

A filled circle (filled circle mark) illustrated on the left side of FIG. 2 and an open circle (open circle mark) illustrated on the right side of FIG. 2 indicate the color of the virtual object before correction. Furthermore, a cross-hatched circle illustrated on the right side of FIG. 2 indicates the color of the virtual object after the color gamut correction. Specifically, the information processing system 1 estimates the parameter for color gamut correction of the virtual object based on each vector indicated by each dotted arrow directed from each sample (filled square mark) of the original color of the real object illustrated in FIG. 2 to each sample (filled star mark) of the color of the real object under the real environment. The information processing system 1 estimates a parameter for color gamut correction of a virtual object based on the above Mathematical Expression 1 or 2, for example. After estimating the parameter, the information processing system 1 corrects the color gamut of the virtual object based on the estimated parameter (solid frame). There are several color correction methods, and the information processing system 1 performs color correction based on the above Mathematical Expression 1 or 2, for example. As a result of the color correction by the information processing system 1, as illustrated on the right side of FIG. 2, the color correction corresponding to a solid arrow directed from the color of the virtual object before correction (open circle mark) to the color of the virtual object after correction (cross-hatched circle mark) is performed. As illustrated in FIG. 2, when there is no observation error, the color of the virtual object can be corrected correctly.

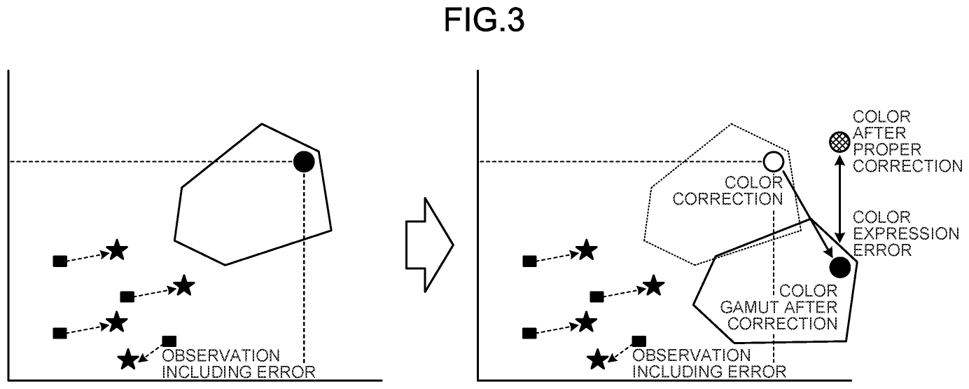

Next, a relationship between estimation of parameters for color gamut correction and an observation error in a case where an observation error is included will be described with reference to FIG. 3. FIG. 3 is a diagram for describing a relationship between estimation of parameters for color gamut correction and an observation error (case where an observation error is included). The example illustrated in FIG. 3 illustrates a case where a part of the sample (filled star mark) of the color of the real object under the real environment is erroneously acquired by the information processing system 1 (case where an observation error is included). For example, in the case of FIG. 3 including an observation error, there are individual vectors indicated by the dotted arrows directed from individual samples (filled square marks) of the original color of the real object toward individual samples (filled star marks) of the color of the real object under the real environment, in which the directions of three vectors are the same, while the direction of one vector is opposite to the directions of the other three vectors. In FIG. 3, the sample (filled star mark) of the color pointed by the vector in a direction opposite to the directions of the other three vectors corresponds to the observation error.

A filled circle (filled circle mark) illustrated on the left side of FIG. 3 and an open circle (open circle mark) illustrated on the right side of FIG. 3 indicate the color of the virtual object before correction. Furthermore, a filled circle (filled circle mark) illustrated on the right side of FIG. 3 indicates the color of the virtual object after the color gamut correction. Furthermore, a cross-hatched circle illustrated on the right side of FIG. 3 indicates the color of the virtual object after correction in a case where proper observation has been performed (case where no observation error is included). Specifically, the information processing system 1 estimates the parameter for color gamut correction of the virtual object based on each vector indicated by each dotted arrow directed from each sample (filled square mark) of the original color of the real object illustrated in FIG. 3 to each sample (filled star mark) of the color of the real object under the real environment. The information processing system 1 estimates a parameter for color gamut correction of a virtual object based on the above Mathematical Expression 1 or 2, for example. After estimating the parameter, the information processing system 1 corrects the color gamut of the virtual object based on the estimated parameter (solid frame). As described above, there are several color correction methods, and the information processing system 1 performs color correction based on the above Mathematical Expression 1 or 2, for example. As a result of the color correction by the information processing system 1, as illustrated on the right side of FIG. 3, the color correction corresponding to a solid arrow directed from the color of the virtual object before correction (open circle mark) to the color of the virtual object after correction (filled circle mark) is performed.

Here, as compared with the example illustrated in FIG. 4, the example illustrated in FIG. 3 is a case having a long distance in the color space between each sample of the color of the real object (filled square mark) and the color of the virtual object before correction (filled circle mark on the left side and open circle mark on the right side of each figure). As illustrated in FIG. 3, a case where the observation error is included and there is a long distance in the color space between each sample of the color of the real object and the color of the virtual object before correction will result in a long distance in the color space between the color (cross-hatched circle mark) of the virtual object after correction in a case where proper observation is performed (case where no observation error is included) and the color (filled circle mark) of the virtual object erroneously corrected. That is, as illustrated in FIG. 3, a case where there is a long distance between each sample of the color of the real object and the color of the virtual object before correction in the color space will lead to a large error of the color of the virtual object after correction caused by the influence of the observation error.

Next, a relationship between estimation of parameters for color gamut correction and the observation error when the observation error is included will be described with reference to FIG. 4. FIG. 4 is a diagram for describing a relationship between estimation of parameters for color gamut correction and an observation error (case where an observation error is included). Similarly to FIG. 3, the example illustrated in FIG. 4 illustrates a case where a part of the sample (filled star mark) of the color of the real object under the real environment is erroneously acquired by the information processing system 1 (case where an observation error is included). For example, similarly to FIG. 3, the case of FIG. 4 including the observation error have individual vectors indicated by the dotted arrows directed from individual samples (filled square marks) of the original color of the real object toward individual samples (filled star marks) of the color of the real object under the real environment, in which the directions of three vectors are the same, while the direction of one vector is opposite to the directions of the other three vectors. In FIG. 4, the sample (filled star mark) of the color pointed by the vector in a direction opposite to the directions of the other three vectors corresponds to the observation error.

A filled circle (filled circle mark) illustrated on the left side of FIG. 4 and an open circle (open circle mark) illustrated on the right side of FIG. 4 indicate the color of the virtual object before correction. Furthermore, a filled circle (filled circle mark) illustrated on the right side of FIG. 4 indicates the color of the virtual object after the color gamut correction. Furthermore, a cross-hatched circle illustrated on the right side of FIG. 4 indicates the color of the virtual object after correction in a case where proper observation has been performed (in a case where no observation error is included). Specifically, the information processing system 1 estimates the parameter for color gamut correction of the virtual object based on each vector indicated by each dotted arrow directed from each sample (filled square mark) of the original color of the real object illustrated in FIG. 4 to each sample (filled star mark) of the color of the real object under the real environment. The information processing system 1 estimates a parameter for color gamut correction of a virtual object based on the above Mathematical Expression 1 or 2, for example. After estimating the parameter, the information processing system 1 corrects the color gamut of the virtual object based on the estimated parameter (solid frame). As described above, there are several color correction methods, and the information processing system 1 performs color correction based on the above Mathematical Expression 1 or 2, for example. As a result of the color correction by the information processing system 1, as illustrated on the right side of FIG. 4, the color correction corresponding to a solid arrow directed from the color of the virtual object before correction (open circle mark) to the color of the virtual object after correction (filled circle mark) is performed.

Here, as compared with the example illustrated in FIG. 3, the example illustrated in FIG. 4 is a case having a short distance in the color space between each sample of the color of the real object (filled square mark) and the color of the virtual object before correction (filled circle mark on the left side and open circle mark on the right side of each figure). As illustrated in FIG. 4, a case where the observation error is included and the distance in the color space between each sample of the color of the real object and the color of the virtual object before correction is long will result in a relatively short distance in the color space between the color (cross-hatched circle mark) of the virtual object after correction in a case where proper observation is performed (case where no observation error is included) and the color (filled circle mark) of the virtual object erroneously corrected. That is, as illustrated in FIG. 4, the case where the distance between each sample of the color of the real object and the color of the virtual object before correction in the color space is short will lead to a small error of the color of the virtual object after correction caused by the influence of the observation error.

As illustrated in FIG. 3, the case where there is a long distance between each sample of the color of the real object and the color of the virtual object before correction in the color space will lead to a high possibility of occurrence of a large error of the color of the virtual object after correction caused by the influence of the observation error. Therefore, in a case where there is a long distance in the color space between each sample of the color of the real object and the color of the virtual object before correction, the information processing system 1 according to the embodiment proposes, to the user, imaging of another real object that complements color information used for correction of the color gamut of the virtual object displayed to be superimposed on the real object.

### 1-3. Configuration of Information Processing System

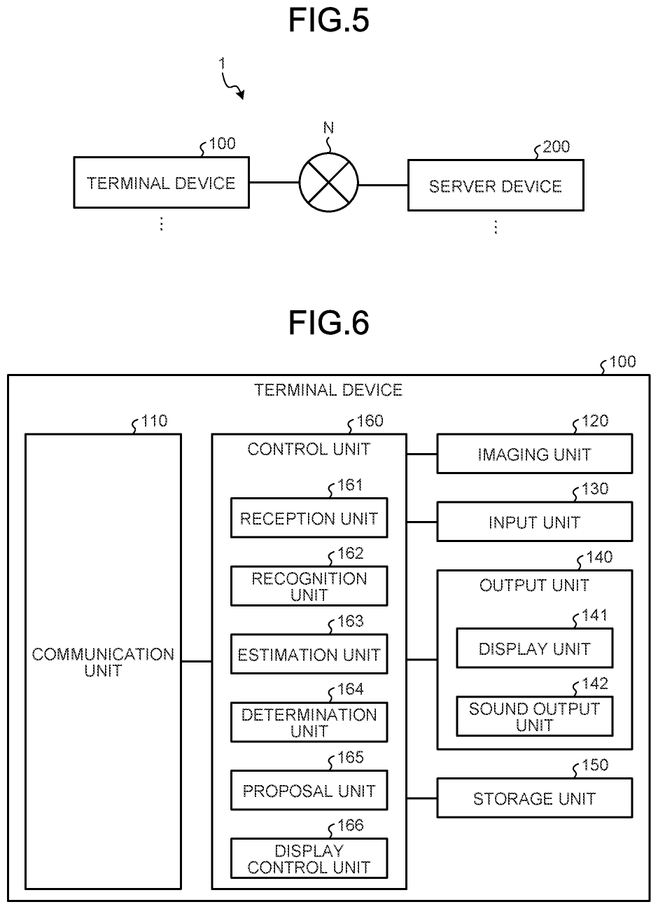

Next, a configuration of the information processing system according to the embodiment will be described with reference to FIG. 5. FIG. 5 is a diagram illustrating a configuration example of an information processing system according to the embodiment. As illustrated in FIG. 5, the information processing system 1 includes a terminal device 100 and a server device 200. The terminal device 100 and the server device 200 are communicably connected to each other in a wired or wireless channel via a predetermined network N. Note that the information processing system 1 illustrated in FIG. 5 may include any number of terminal devices 100 and any number of server devices 200.

The terminal device 100 is an information processing apparatus used by a user. The terminal device 100 is implemented by devices such as a desktop personal computer (PC), a laptop PC, a smartphone, a tablet terminal, a mobile phone, or a personal digital assistant (PDA). In the example illustrated in FIG. 1, the terminal device 100 is a desktop PC.

The server device 200 is an information processing apparatus that provides an electronic commerce service. The server device 200 stores information related to a product. Specifically, the server device 200 stores identification information that identifies a product in association with the shape, feature point, and color information regarding the product. The server device 200 provides product information in response to a request from the terminal device 100. Furthermore, the server device 200 stores information related to a product purchase history of the user.

### 1-4. Configuration of terminal device

Next, a configuration of the terminal device 100 according to the embodiment will be described with reference to FIG. 6. FIG. 6 is a diagram illustrating an example of the terminal device 100 according to the embodiment. As illustrated in FIG. 6, the terminal device 100 includes a communication unit 110, an imaging unit 120, an input unit 130, an output unit 140, a storage unit 150, and a control unit 160.

### Communication Unit 110

The communication unit 110 is implemented by a network interface card (NIC), for example. The communication unit 110 is connected to the network in a wired or wireless channel, and transmits and receives information to and from the server device 200, for example.

### Imaging Unit 120

The imaging unit 120 has a function of capturing various types of information regarding the user or the surrounding environment. In the example illustrated in FIG. 1, the imaging unit 120 includes a camera C1 installed at the top of the terminal device 100. For example, the imaging unit 120 images an object presented on the camera. The imaging unit 120 includes an optical system such as a lens, and an imaging element such as a charge coupled device (CCD) image sensor or a complementary metal oxide semiconductor (CMOS) sensor.

### Input Unit 130

The input unit 130 is an input device that receives various operations from the user. For example, the input unit 130 is implemented by a keyboard, a mouse, an operation key, and the like.

### Output Unit 140

The output unit 140 includes a display unit 141 and a sound output unit 142. The display unit 141 is a display device for displaying various types of information. For example, the display unit 141 is implemented by a liquid crystal display or the like. When a touch panel is adopted as the terminal device 100, the input unit 130 and the display unit 141 are integrated.

The sound output unit 142 reproduces a sound signal under the control of the control unit 160.

### Storage Unit 150

The storage unit 150 stores various data and programs. Specifically, the storage unit 150 stores programs and parameters for the control unit 160 to execute each function. For example, the storage unit 150 stores information regarding an AR marker used by the recognition unit 162 to recognize the AR marker, and information regarding a virtual object to be displayed in the AR by the display control unit 166. The storage unit 150 is implemented by semiconductor memory elements such as random access memory (RAM) or flash memory, or storage devices such as a hard disk or an optical disk.

### Control Unit 160

The control unit 160 is a controller, and is implemented by execution of various programs (corresponding to an example of an information processing program) stored in a storage device inside the terminal device 100 by a central processing unit (CPU), a micro processing unit (MPU), or the like, using the RAM as a work area, for example. In addition, the control unit 160 is a controller, and is implemented by an integrated circuit such as an application specific integrated circuit (ASIC) or a field programmable gate array (FPGA).

As illustrated in FIG. 6, the control unit 160 includes a reception unit 161, a recognition unit 162, an estimation unit 163, a determination unit 164, a proposal unit 165, and a display control unit 166, and implements or executes operations of information processing described below. The internal configuration of the control unit 160 is not limited to the configuration illustrated in FIG. 6, and may be another configuration as long as it is a configuration that performs information processing described below.

### Reception Unit 161

The reception unit 161 receives selection of a virtual object from the user. Specifically, the reception unit 161 receives a virtual object selection operation from the user via the input unit 130. When having received the selection operation of the virtual object from the user, the reception unit 161 requests the server device 200 for information related to the selected virtual object. Subsequently, the reception unit 161 acquires information related to the virtual object from the server device 200. For example, the reception unit 161 acquires information related to the shape of the virtual object and color information regarding the virtual object. For example, the reception unit 161 acquires a sample of the color of the virtual object.

In the example illustrated in FIG. 1, the reception unit 161 transmits a product ID “G1” identifying the virtual object (product G1) selected by the user U1, and requests the server device 200 for information regarding the virtual object (product G1). Subsequently, the reception unit 161 acquires information regarding the shape of the virtual object (product G1) and color information regarding the virtual object (product G1) from the server device 200. For example, the reception unit 161 acquires a sample of the color of the virtual object (product G1).

Furthermore, the reception unit 161 receives designation of a real object to be used as a marker when superimposing a virtual object from the user. Specifically, the reception unit 161 acquires an image of a real object (marker) captured by the imaging unit 120. Subsequently, the reception unit 161 requests the server device 200 for information necessary for recognizing the real object (marker). The reception unit 161 then acquires information necessary for recognizing the real object (marker) from the server device 200. For example, the reception unit 161 acquires feature points of a real object (marker) and color information regarding the real object (marker). For example, the reception unit 161 acquires a sample of the color of a real object (marker).

In the example illustrated in FIG. 1, the reception unit 161 acquires an image of a real object (product G2) captured by the imaging unit 120. Subsequently, the reception unit 161 transmits the image of the real object (product G2) and requests the server device 200 for information necessary for recognizing the real object (product G2). The reception unit 161 then acquires feature points of the real object (product G2) and the color information regarding the real object (product G2) from the server device 200. For example, the reception unit 161 acquires a sample of the color of the real object (product G2).

### Recognition Unit 162

The recognition unit 162 acquires an image of a real object (marker) from the reception unit 161. Subsequently, based on the acquired image of the real object, the recognition unit 162 recognizes the real object (marker) and estimates the position and posture of the real object. For example, the recognition unit 162 compares the feature points of the real object (marker) or the color information regarding the real object (marker) acquired from the server device 200 with the image of the real object (marker), recognizes the real object (marker), and estimates the position and posture of the real object (marker).

In the example illustrated in FIG. 1, the recognition unit 162 acquires an image of the real object (product G2) from the reception unit 161. Subsequently, based on the acquired image of the real object (product G2), the recognition unit 162 recognizes the real object (product G2) and estimates the position and posture of the real object. For example, the recognition unit 162 compares feature points of the real object (product G2) or the color information regarding the real object (product G2) acquired from the server device 200 with the image of the real object (product G2), recognizes the real object (product G2), and estimates the position and posture of the real object (product G2).

Furthermore, the recognition unit 162 acquires, from the real object (marker), a sample of the color of the real object (marker) under the real environment. Specifically, the recognition unit 162 acquires a sample of the color of the real object (marker) under the real environment based on the acquired image of the real object (marker).

In the example illustrated in FIG. 1, the recognition unit 162 acquires, from the real object (product G2), a sample of the color of the real object (product G2) in the real environment. Specifically, the recognition unit 162 acquires a sample of the color of the real object (product G2) under the real environment based on the acquired image of the real object (product G2).

The recognition unit 162 acquires an image of another real object captured by the imaging unit 120. Subsequently, the recognition unit 162 recognizes the another real object based on the acquired image of the another real object, and estimates the position and posture of the another real object. Furthermore, the recognition unit 162 acquires a sample of the color of the another real object under the real environment based on the acquired image of the another real object.

In the example illustrated in FIG. 1, the recognition unit 162 acquires an image of another real object (product G3) captured by the camera C1. Subsequently, based on the acquired image of the another real object (product G3), the recognition unit 162 recognizes the another real object (product G3) and estimates the position and posture of the another real object (product G3). Furthermore, the recognition unit 162 acquires a sample of the color of the another real object (product G3) under the real environment based on the acquired image of the another real object (product G3).

### Estimation Unit 163

The estimation unit 163 estimates a parameter for color gamut correction of a virtual object. The estimation unit 163 estimates a parameter for color gamut correction in the imaging unit 120 based on the sample of the color of the real object under the real environment acquired by the recognition unit 162. Specifically, the estimation unit 163 calculates a difference vector in the color space between the color value of the sample of the color of the real object (marker) acquired by the reception unit 161 and the color value of the sample of the color of the real object (marker) under the real environment acquired by the recognition unit 162. Subsequently, based on the calculated difference vector, the estimation unit 163 estimates a parameter for color gamut correction of the virtual object. For example, the estimation unit 163 estimates the parameter for color gamut correction of the virtual object based on the above Mathematical Expression 1 or 2.

In the example illustrated in FIG. 1, the estimation unit 163 calculates a difference vector in the color space between the color value of the sample of the color of the real object (product G2) acquired by the reception unit 161 and the color value of the sample of the color of the real object (product G2) under the real environment acquired by the recognition unit 162. Subsequently, based on the calculated difference vector, the estimation unit 163 estimates a parameter for color gamut correction of the virtual object (product G1).

### Determination Unit 164

After the estimation unit 163 has estimated the parameter, the determination unit 164 determines whether the color information necessary to express the color of the virtual object is sufficient. Specifically, the determination unit 164 determines whether the color information necessary for expressing the color of the virtual object is sufficient based on a comparison between the color information regarding the real object and the color information regarding the virtual object. For example, when the distance between the color value of the real object and the color value of the virtual object in the color space exceeds a predetermined threshold, the determination unit 164 determines that the color information necessary for expressing the color of the virtual object is not sufficient. Alternatively, in a case where the area in the color space of the region where the color gamut of the real object and the color gamut of the virtual object overlap is less than a predetermined threshold, the determination unit 164 determines that the color information necessary for expressing the color of the virtual object is not sufficient.

Having determined that the color information necessary for expressing the color of the virtual object is not sufficient, the determination unit 164 determines that it is necessary to perform imaging of another real object (also referred to as an additional object) that complements the color information expressing the color of the virtual object. Having determined that it is necessary to perform imaging of another real object that complements the color information expressing the color of the virtual object, the determination unit 164 requests the server device 200 to determine the presence or absence of information regarding the another real object that complements the color information expressing the color of the virtual object.

In the example illustrated in FIG. 1, the determination unit 164 determines that color information expressing the color of the virtual object (product G1) is insufficient. When having determined that the color information expressing the color of the virtual object (product G1) is insufficient, the determination unit 164 requests a server device 200 to determine whether there is information regarding another real object (different from the product G2) that complements the insufficient color information.

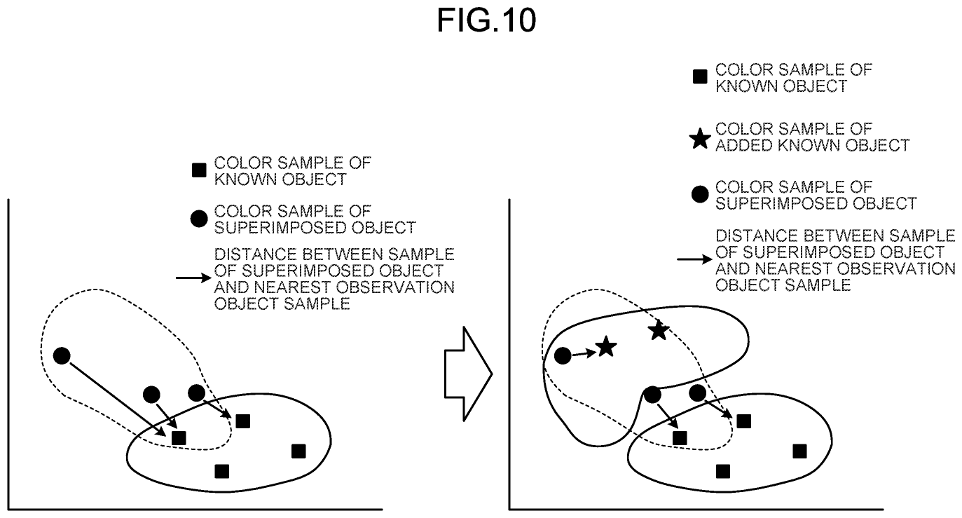

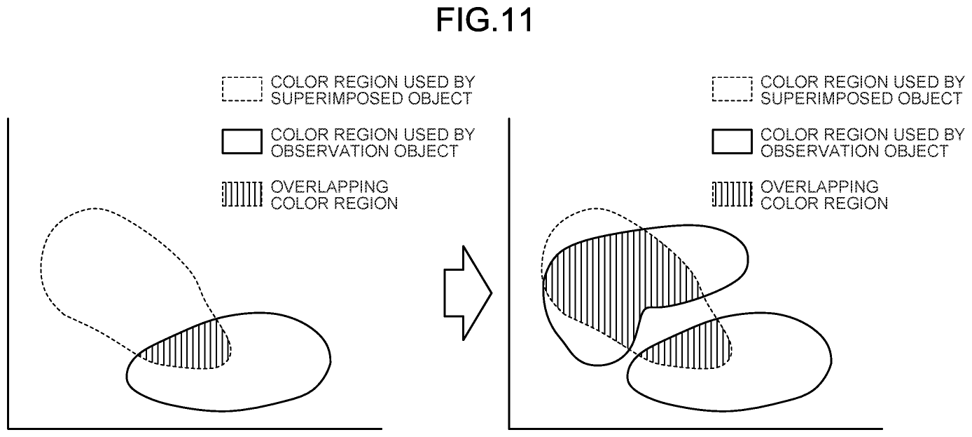

Here, the determination processing regarding the necessity of complementation of color information expressing the color of a virtual object will be described with reference to FIGS. 10 and 11. First, description will be given with reference to FIG. 10. FIG. 10 is a diagram illustrating an example of color information complement necessity determination processing according to the embodiment of the present disclosure. In FIG. 10, the determination unit 164 calculates distances in the CIE Lab space of all the color samples of the captured real object (also referred to as a known object) for each color sample of the virtual object, and calculates the shortest distance. Subsequently, in a case where one or several samples exceed a certain threshold in the shortest distance of all the color samples of the virtual object, the determination unit 164 makes a judgment of inexpressible. Subsequently, after making a judgment of inexpressible, the determination unit 164 requests the server device 200 to give a plurality of objects having colors close to the sample exceeding the threshold as candidates for additional observation.

Next, a description will be given with reference to FIG. 11. FIG. 11 is a diagram illustrating an example of color information complement necessity determination processing according to the embodiment of the present disclosure. In FIG. 11, in a case where the color correction is expressed as a correction field in the CIE Lab space, the determination unit 164 calculates a region occupied by the color of the virtual object as prior information. Next, in observation of the real object, the determination unit 164 calculates the coverage of the region occupied by the color sample of the real object with respect to the color region of the virtual object. In a case where the coverage of the region occupied by the color sample of the real object is less than a predetermined threshold, the determination unit 164 makes a judgment of inexpressible. Subsequently, after making a judgment of inexpressible, the determination unit 164 requests the server device 200 to give a plurality of objects having colors that can compensate for the insufficient region as candidates for additional observation.

### Proposal Unit 165

The proposal unit 165 proposes, to the user, imaging of another real object that complements color information used for correcting a color gamut of a virtual object displayed to be superimposed on a predetermined real object. Specifically, the proposal unit 165 acquires, from the server device 200, information regarding the another real object that complements color information expressing the color of the virtual object. Having acquired information regarding the another real object that complements the color information expressing the color of the virtual object, the proposal unit 165 displays an illustration (“?” mark, etc.) or a message prompting additional imaging of another real object on the display unit 141 together with an image of the another real object. For example, the proposal unit 165 proposes, to the user, imaging of another real object selected based on the product purchase history of the user. The proposal unit 165 proposes, to the user, imaging of the another real object selected from the products purchased by the user.

Furthermore, the proposal unit 165 proposes imaging of another real object to the user based on a comparison between color information regarding a predetermined real object and color information regarding a virtual object. Specifically, in a case where the distance between the color value of the predetermined real object and the color value of the virtual object in the color space exceeds a predetermined threshold, the proposal unit 165 proposes imaging of another real object to the user. Specifically, when the determination unit 164 has determined that the distance between the color value of the predetermined real object and the color value of the virtual object in the color space exceeds a predetermined threshold, the proposal unit 165 proposes, to the user, imaging of the another real object acquired from the server device 200.

Alternatively, in a case where the area in the color space of the region where the color gamut of the predetermined real object and the color gamut of the virtual object overlap is less than a predetermined threshold, the proposal unit 165 proposes, to the user, imaging of the another real object. Specifically, when the determination unit 164 has determined that the area in the color space of the region in which the color gamut of the predetermined real object and the color gamut of the virtual object overlap is less than the predetermined threshold, the proposal unit 165 proposes, to the user, imaging of another real object acquired from the server device 200.

In the example illustrated in FIG. 1, the proposal unit 165 acquires information regarding another real object (product G3) from the server device 200. Having acquired information regarding the another real object (product G3), the proposal unit 165 proposes to the user U1 to additionally image the another real object (product G3).

### Display Control Unit 166

The display control unit 166 corrects the color gamut of the virtual object based on color information acquired by imaging of another real object presented by the user. The display control unit 166 corrects the color gamut of the virtual object as described above with reference to FIGS. 2 to 4. Furthermore, after correcting the color gamut of the virtual object, the display control unit 166 controls the display unit 141 to display the virtual object to be superimposed on the real object.

### 1-5. Configuration of Server Device

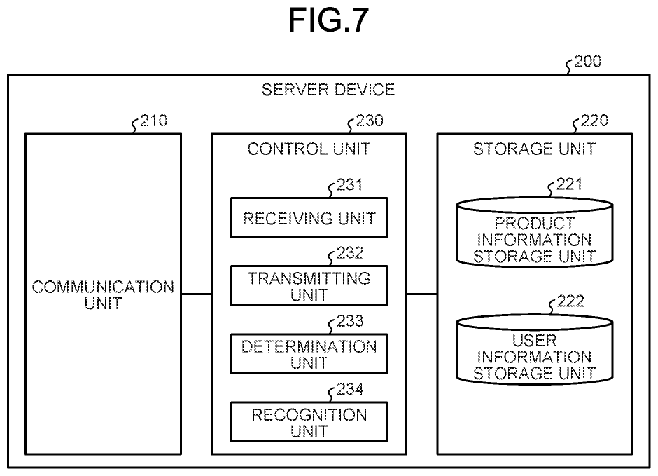

Next, the server device 200 according to the embodiment will be described with reference to FIG. 7. FIG. 7 is a diagram illustrating a configuration example of the server device 200 according to the embodiment. As illustrated in FIG. 7, the server device 200 includes a communication unit 210, a storage unit 220, and a control unit 230.

### Communication Unit 210

The communication unit 210 is implemented by a NIC, for example. The communication unit 210 is connected to the network in a wired or wireless channel, and transmits and receives information to and from the terminal device 100, for example.

### Storage Unit 220

The storage unit 220 stores various data and programs. The storage unit 220 is implemented by semiconductor memory elements such as flash memory, or storage devices such as a hard disk or an optical disk. As illustrated in FIG. 7, the storage unit 220 includes a product information storage unit 221 and a user information storage unit 222.

### Product Information Storage Unit 221

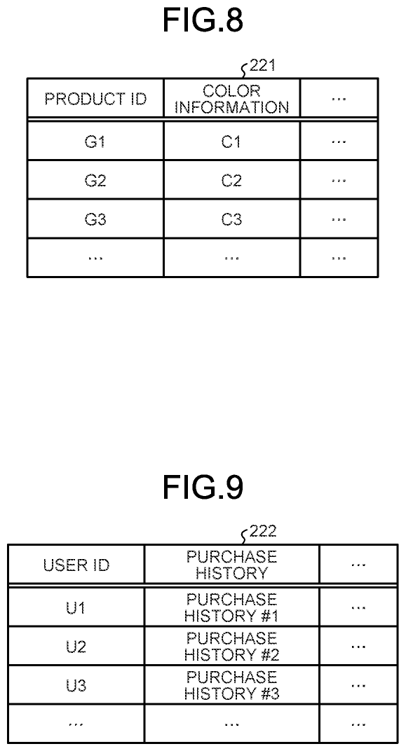

The product information storage unit 221 stores various types of information regarding products. FIG. 8 illustrates an example of the product information storage unit 221. FIG. 8 is a diagram illustrating an example of a product information storage unit according to the embodiment of the present disclosure. In the example illustrated in FIG. 8, the product information storage unit 221 includes items such as “product ID” and “color information”.

The “product ID” indicates identification information that identifies a product. The “color information” indicates information related to the color of the product.

### User Information Storage Unit 222

The user information storage unit 222 stores various types of information regarding the user. FIG. 9 illustrates an example of the product information storage unit 221. FIG. 9 is a diagram illustrating an example of a user information storage unit according to the embodiment of the present disclosure. In the example illustrated in FIG. 9, the user information storage unit 222 includes items such as “user ID” and “purchase history”.

The “user ID” indicates identification information that identifies a user. The “purchase history” indicates information related to the product purchase history of the user.

### Control Unit 230

Returning to the description of FIG. 7, the control unit 230 is a controller, and is implemented by execution of various programs (corresponding to an example of an information processing program) stored in a storage device inside the server device 200, by a CPU, an MPU, or the like using a RAM as a work area, for example. Furthermore, the control unit 230 is a controller, and is implemented by using an integrated circuit such as an ASIC or an FPGA, for example.

As illustrated in FIG. 7, the control unit 230 includes a receiving unit 231, a transmitting unit 232, a determination unit 233, and a recognition unit 234, and implements or executes operations of information processing described below. The internal configuration of the control unit 230 is not limited to the configuration illustrated in FIG. 7, and may be another configuration as long as it is a configuration that performs information processing described below.

### Receiving Unit 231

The receiving unit 231 receives a request for information related to a virtual object from the terminal device 100. Furthermore, the receiving unit 231 receives a request for information necessary for recognizing a real object (marker) from the terminal device 100.

### Transmitting Unit 232

When the receiving unit 231 has receives the request for the information regarding a virtual object, the transmitting unit 232 transmits the information regarding the virtual object to the terminal device 100. Specifically, the transmitting unit 232 refers to the product information storage unit 221 to acquire information related to the shape of the virtual object and color information regarding the virtual object.

Subsequently, the transmitting unit 232 transmits information related to the shape of the virtual object and color information regarding the virtual object.

When the receiving unit 231 has received a request for information necessary for recognizing a real object (marker), the transmitting unit 232 transmits information necessary for recognizing the real object (marker) to the terminal device 100. Specifically, the transmitting unit 232 refers to the product information storage unit 221 to acquire the feature point of the real object (marker) and the color information regarding the real object (marker). Subsequently, the transmitting unit 232 transmits the feature point of the real object (marker) and the color information regarding the real object (marker).

### Determination Unit 233

The determination unit 233 receives, from the terminal device 100, a determination request regarding the presence or absence of information related to another real object (hereinafter, also referred to as an additional object) capable of complementing color information expressing the color of the virtual object. In response to a request from the terminal device 100, the determination unit 233 determines the presence or absence of information related to the additional object. Specifically, having received the request for determining the presence or absence of the information regarding the additional object, the determination unit 233 refers to the user information storage unit 222 to determine whether the user of the terminal device 100 as the transmission source has a purchase history of the product. When determining that the user has a purchase history of the product, the determination unit 233 specifies the product purchased by the user. Having specified the product purchased by the user, the determination unit 233 refers to the product information storage unit 221 to acquire color information regarding the product purchased by the user. Having acquired the color information regarding the product purchased by the user, the determination unit 233 selects a product that can complement the color information expressing the color of the virtual object from among the products purchased by the user. Subsequently, the determination unit 233 transmits information related to the selected product to the terminal device 100.

In contrast, when having determined that the user has no purchase history of the product, the determination unit 233 requests the terminal device 100 to transmit a current image captured by the camera of the terminal device 100.

In the example illustrated in FIG. 1, the determination unit 233 receives a determination request of the information from the terminal device 100. When having received the determination request of the information, the determination unit 233 acquires information regarding the product purchased in the past by the user U1 based on the product purchase history of the user U1. Subsequently, the determination unit 233 selects a product G3 as another real object that can complement the insufficient color information from among the products purchased by the user U1 in the past. Specifically, the product G3 is a red smartphone. After having selected the another real object (product G3) that can complement the insufficient color information, the determination unit 233 transmits information regarding the selected another real object (product G3) to the terminal device 100.

### Recognition Unit 234

The recognition unit 234 acquires the current image captured by the camera of the terminal device 100 from the terminal device 100. When having acquired the image, the recognition unit 234 determines whether the acquired image includes an image of a real object capable of complementing color information expressing the color of the virtual object. When having determined that the acquired image includes an image of a real object capable of complementing color information expressing the color of the virtual object, the recognition unit 234 transmits, to the terminal device 100, information related to the real object capable of complementing the color information expressing the color of the virtual object. In contrast, when having determined that the acquired image does not include an image of a real object capable of complementing color information expressing the color of the virtual object, the recognition unit 234 refers to the product information storage unit 221 to select a real object capable of complementing the color information expressing the color of the virtual object, and transmits information related to the selected real object to the terminal device 100.

### 1-6. Flow Diagram of Information Processing

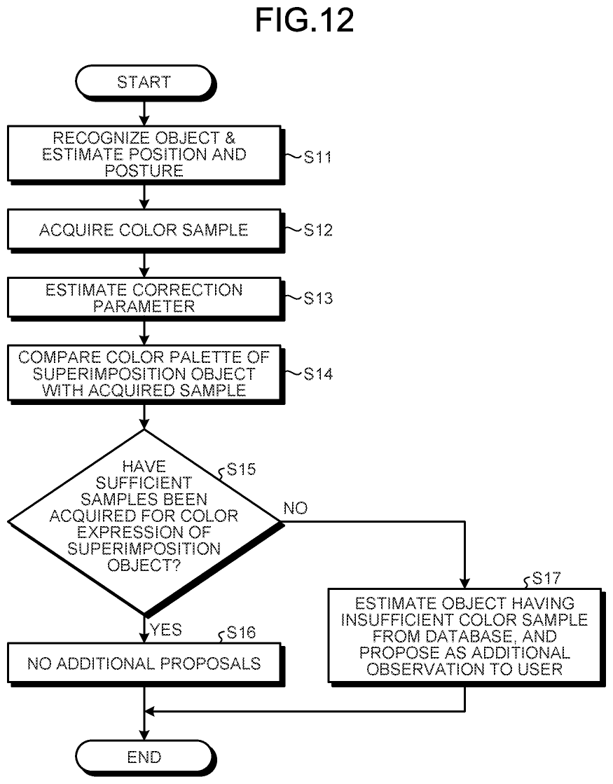

Next, a procedure of information processing performed by the information processing system according to the embodiment will be described with reference to FIG. 12. FIG. 12 is a flowchart illustrating an information processing procedure according to the embodiment. In the example illustrated in FIG. 12, the information processing system 1 recognizes an object (real object) used as a marker when superimposing a virtual object, and estimates the position and posture of the object (step S11).

Subsequently, the information processing system 1 acquires a sample of the color of the object (step S12). Subsequently, the information processing system 1 estimates a parameter for color gamut correction based on the acquired sample of the color of the object (step S13).

Subsequently, the information processing system 1 compares a color palette of the superimposition object (virtual object) with the acquired sample of the color of the object (step S14).

Subsequently, the information processing system 1 determines whether the acquired sample of the color is sufficient to express the color of the superimposition object (virtual object) (step S15). When having determined that the acquired sample of the color is sufficient to express the color of the superimposition object (virtual object) (Yes in step S15), the information processing system 1 does not propose observation (imaging) of an additional object to the user (step S16).

In contrast, when having determined that the acquired sample of the color is not sufficient to express the color of the superimposition object (virtual object) (No in step S15), the information processing system 1 estimates an object having a sample of an insufficient color from the database (for example, the product information storage unit 221) and proposes observation (imaging) of an additional object to the user (step S17).

### 1-7. Sequence Diagram of Information Processing

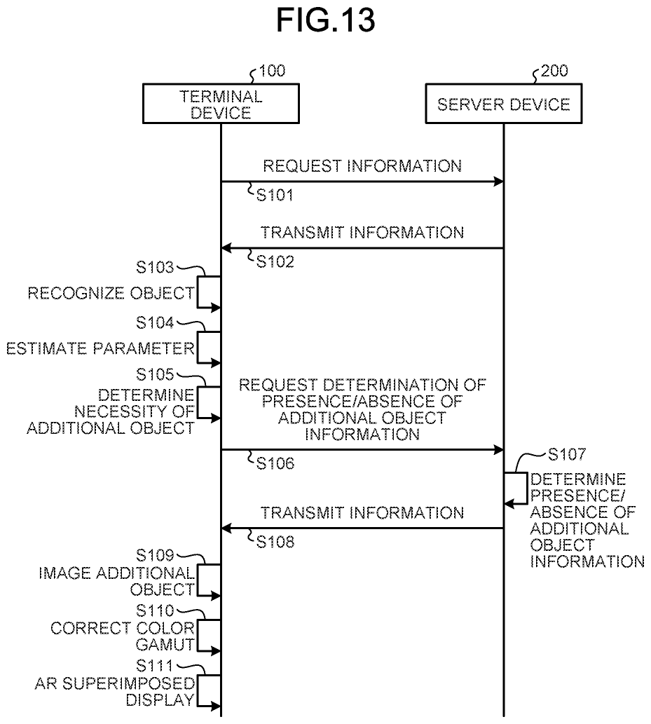

Next, a procedure of information processing by each device according to the embodiment will be described with reference to FIG. 13. FIG. 13 is a sequence diagram illustrating an information processing procedure according to the embodiment. In the example illustrated in FIG. 13, the terminal device 100 requests the server device 200 for information related to a virtual object to be displayed to be superimposed by using augmented reality. Furthermore, the terminal device 100 requests the server device 200 for information necessary for recognizing an object used as a marker when superimposing the virtual object (hereinafter, also referred to as a marker) (step S101).

The server device 200 receives a request for information from the terminal device 100. Having receiving the request for information, the server device 200 transmits information regarding the shape of the virtual object and color information regarding the virtual object to the terminal device 100 as the information regarding the virtual object.

Furthermore, the server device 200 transmits the feature points of the marker and the color information regarding the marker to the terminal device 100 as information necessary for recognizing the marker (step S102).

The terminal device 100 receives the information related to the virtual object and the information related to the marker from the server device 200. Having receiving the information regarding the marker, the terminal device 100 recognizes the marker (step S103). Subsequently, after recognizing the marker, the terminal device 100 estimates a parameter for color gamut correction of the virtual object (step S104). Subsequently, after estimating the parameter, the terminal device 100 determines the necessity of imaging of the additional object (step S105).

After determining that imaging of the additional object is necessary, the terminal device 100 requests the server device 200 to determine the presence or absence of information related to the additional object (step S106). The server device 200 determines the presence or absence of information related to the additional object. When determining that the information related to the additional object exists, the server device 200 transmits the information related to the additional object to the terminal device 100 (step S108).

The terminal device 100 receives the information related to the additional object from the server device 200. Having received the information regarding the additional object, the terminal device 100 captures an image of the additional object (step S109). Subsequently, after imaging the additional object, the terminal device 100 corrects the color gamut of the virtual object based on the sample of the color acquired from the imaged additional object (step S110). Subsequently, after correcting the color gamut of the virtual object, the terminal device 100 superimposes the virtual object after the color gamut correction on the marker so as to be displayed by using AR (step S111).

### 1-8. Modification According to Embodiment

### 1-8-1. Combination of Color Correction Marker and Superimposition Marker

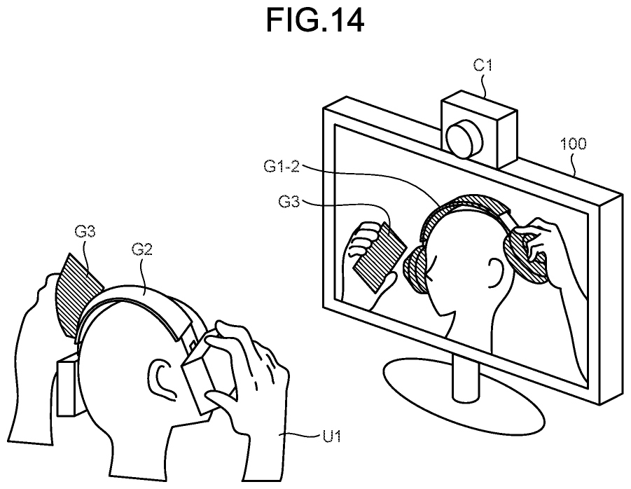

Next, a modification of the embodiment will be described with reference to FIG. 14. FIG. 14 is a view illustrating an example of information processing according to a modification of the present disclosure. In the example illustrated in FIG. 14, a real object for a marker (product G2) and a real object for color correction (product G3) are used in combination. In this case, since the real object (product G2) for the marker is similar to the virtual object (product G1), a tactile sensation close to the virtual object or a deformation of the object can be expressed as the AR experience. In the example illustrated in FIG. 14, the real object for the marker itself does not need to have a color palette similar to that of the virtual object, making it possible to use an object having a similarity only in shape for the marker and compensate the color approximation by the real object for color correction.

### 1-8-2. Color Sample for Box of Product

The proposal unit 165 may propose, to the user, imaging of another real object selected from a packaging container of the product purchased by the user. For example, the proposal unit 165 proposes, to the user, imaging of another real object selected based on color information regarding a box of a product purchased by the user.

### 1-8-3. Proposal of Object Based on Captured Image

Furthermore, the proposal unit 165 proposes, to the user, imaging of another real object selected based on the image captured by the terminal device of the user. The proposal unit 165 proposes, to the user, imaging of another real object selected from the objects included in the image captured by the terminal device of the user.

### 1-8-4. Method of Determining Object Proposal Priority

In addition, the proposal unit 165 proposes, to the user, imaging of another real object whose distance in the color space between the color value of the another real object and the color value of the virtual object is less than a predetermined threshold with higher priority over the another real object whose distance is the predetermined threshold or more.

In addition, the proposal unit 165 proposes, to the user, imaging of another real object in which the color information regarding the another real object does not exist in the color information regarding the predetermined real object with higher priority over imaging of the another real object in which the color information regarding the another real object exists in the color information regarding the predetermined real object.

### 2. Other Embodiments

Although the above-described embodiment is an example in which the terminal device 100 and the server device 200 are separate devices, the terminal device 100 and the server device 200 may be an integrated device.

### 3. Effects According to Present Disclosure

As described above, the information processing apparatus (terminal device 100 in the embodiment) according to the present disclosure includes the proposal unit (proposal unit 165 in the embodiment) and the display control unit (display control unit 166 in the embodiment). The proposal unit 165 proposes, to the user, imaging of another real object that complements color information used for correcting a color gamut of a virtual object displayed to be superimposed on a predetermined real object. The display control unit 166 corrects the color gamut of the virtual object based on color information acquired by imaging of another real object presented by the user.

With this configuration, in a case where the color information necessary for expressing the color of the virtual object is insufficient, the information processing apparatus proposes, to the user, observation of another real object that complements the insufficient color information, and corrects the color gamut of the virtual object based on the color information of the another real object. With this correction, the information processing apparatus can more easily correct the color gamut of the virtual object by using an object near the user as the color sample. This makes it possible for the information processing apparatus to improve convenience regarding color correction of the virtual object.

Furthermore, the proposal unit 165 proposes, to the user, imaging of another real object selected from known objects of which color information is known. Furthermore, the proposal unit 165 proposes, to the user, imaging of another real object selected based on a product purchase history of the user. Furthermore, the proposal unit 165 proposes, to the user, imaging of another real object selected from products purchased by the user.

With this configuration, the information processing apparatus can more easily correct the color gamut of the virtual object by using a product near the user as the color sample.

In addition, the proposal unit 165 proposes, to the user, imaging of another real object selected from a packaging container of the product purchased by the user.

With this configuration, the information processing apparatus can more easily correct the color gamut of the virtual object by using a box of the product near the user as the color sample.

Furthermore, the proposal unit 165 proposes, to the user, imaging of another real object selected based on the image captured by the terminal device of the user. In addition, the proposal unit 165 proposes, to the user, imaging of another real object selected from the objects included in the image captured by the terminal device of the user.

With this configuration, in a case where there is no product purchased by the user, the information processing apparatus proposes, to the user, the use of an object included in an image captured by the terminal device of the user as a color sample, thereby enabling color gamut correction of the virtual object more easily.

Furthermore, the proposal unit 165 proposes imaging of another real object to the user based on a comparison between color information regarding a predetermined real object and color information regarding a virtual object. In addition, in a case where the distance between the color value of the predetermined real object and the color value of the virtual object in the color space exceeds a predetermined threshold, the proposal unit 165 proposes imaging of another real object to the user. Moreover, in a case where the area in the color space of the region where the color gamut of the predetermined real object and the color gamut of the virtual object overlap is less than a predetermined threshold, the proposal unit 165 proposes imaging of another real object to the user.

In general, the case where there is a long distance between each sample of the color of the real object and the color of the virtual object before correction in the color space will lead to the possibility of occurrence of a large error of the color of the virtual object after correction caused by the influence of the observation error. Therefore, in a case where the error in the color of the virtual object after the correction is likely to increase, the information processing apparatus proposes imaging of another real object to the user, thereby enabling better color correction.

In addition, the proposal unit 165 proposes, to the user, imaging of another real object whose distance in the color space between the color value of the another real object and the color value of the virtual object is less than a predetermined threshold with higher priority over the another real object whose distance is the predetermined threshold or more.

With this configuration, the information processing apparatus preferentially proposes an object having a higher effect of color correction improvement by complementing the color information, enabling better color correction.

In addition, the proposal unit 165 proposes, to the user, imaging of another real object in which the color information regarding the another real object does not exist in the color information regarding the predetermined real object with higher priority over imaging of the another real object in which the color information regarding the another real object exists in the color information regarding the predetermined real object.

With this configuration, the information processing apparatus preferentially proposes an object having a higher effect of color correction improvement by complementing the color information, enabling better color correction.

### 4. Hardware Configuration

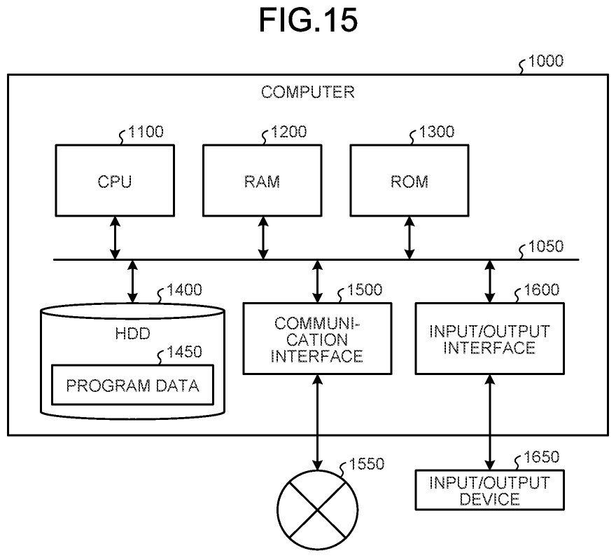

The information devices such as the terminal device 100 and the server device 200 according to the above-described embodiment and modification are implemented by a computer 1000 having a configuration as illustrated in FIG. 15, for example. FIG. 15 is a hardware configuration diagram illustrating an example of the computer 1000 that implements the functions of the information processing apparatus such as the terminal device 100 and the server device 200. Hereinafter, the terminal device 100 according to the embodiment will be described as an example. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops the program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, and the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 to the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, or semiconductor memory.

For example, when the computer 1000 functions as the terminal device 100 according to the embodiment, the CPU 1100 of the computer 1000 executes the information processing program loaded on the RAM 1200 so as to implement the functions of the control unit 160 or the like. Furthermore, the HDD 1400 stores the information processing program according to the present disclosure or data in the storage unit 150. While the CPU 1100 executes program data 1450 read from the HDD 1400, the CPU 1100 may acquire these programs from another device via the external network 1550, as another example.

Note that the present technology can also have the following configurations.

(1)

An information processing apparatus comprising:

a proposal unit that proposes, to a user, imaging of another real object that complements color information used for correcting a color gamut of a virtual object displayed to be superimposed on a predetermined real object; and

a display control unit that corrects the color gamut of the virtual object based on color information acquired by imaging of the another real object presented by the user.

(2)

The information processing apparatus according to (1),

wherein the proposal unit

proposes, to the user, imaging of the another real object selected from known objects of which color information is known.

(3)

The information processing apparatus according to (1) or (2),

wherein the proposal unit

proposes, to the user, imaging of the another real object selected based on a product purchase history of the user.

(4)

The information processing apparatus according to (3),

wherein the proposal unit

proposes, to the user, imaging of the another real object selected from products purchased by the user.

(5)

The information processing apparatus according to (3) or

(4), wherein the proposal unit proposes, to the user, imaging of the another real object selected from a packaging container of a product purchased by the user.

(6)

The information processing apparatus according to (1) or (2), wherein the proposal unit proposes, to the user, imaging of the another real object selected based on an image captured by a terminal device of the user.

(7)

The information processing apparatus according to (6), wherein the proposal unit proposes, to the user, imaging of the another real object selected from objects included in the image captured by the terminal device of the user.

(8)

The information processing apparatus according to any of (1) to (7),

wherein the proposal unit

proposes, to the user, imaging of the another real object based on a comparison between color information regarding the predetermined real object and color information regarding the virtual object.

(9)

The information processing apparatus according to any of (1) to (8), wherein, in a case where a distance in a color space between a color value of the predetermined real object and a color value of the virtual object exceeds a predetermined threshold, the proposal unit proposes, to the user, imaging of the another real object.

(10)

The information processing apparatus according to any of (1) to (9),

wherein, in a case where an area, in a color space, of a region in which a color gamut of the predetermined real object and the color gamut of the virtual object overlap with each other is less than a predetermined threshold, the proposal unit

proposes, to the user, imaging of the another real object.

(11)

The information processing apparatus according to any of (1) to (10),

wherein the proposal unit

proposes, to the user, imaging of the another real object in which a distance in a color space between a color value of the another real object and a color value of the virtual object is smaller than a predetermined threshold with higher priority over the another real object in which the distance between the color value of the another real object and the color value of the virtual object is the predetermined threshold or more.

(12)

The information processing apparatus according to any of (1) to (11),

wherein the proposal unit

proposes, to the user, imaging of the another real object in which color information regarding the another real object does not exist in color information regarding the predetermined real object with higher priority over the another real object in which the color information regarding the another real object exists in the color information regarding the predetermined real object.

(13)

An information processing method in which a computer executes processing of:

proposing, to a user, imaging of another real object that complements color information used for correcting a color gamut of a virtual object displayed to be superimposed on a predetermined real object; and

correcting the color gamut of the virtual object based on color information acquired by imaging of the another real object presented by the user. (14)

An information processing program for causing a computer to execute:

a proposal procedure of proposing, to a user, imaging of another real object that complements color information used for correcting a color gamut of a virtual object displayed to be superimposed on a predetermined real object; and

a display control procedure of correcting the color gamut of the virtual object based on color information acquired by imaging of the another real object presented by the user.

### REFERENCE SIGNS LIST

1 INFORMATION PROCESSING SYSTEM
100 TERMINAL DEVICE
110 COMMUNICATION UNIT
120 IMAGING UNIT
130 INPUT UNIT
140 OUTPUT UNIT
141 DISPLAY UNIT
142 SOUND OUTPUT UNIT
150 STORAGE UNIT
160 CONTROL UNIT
161 RECEPTION UNIT
162 RECOGNITION UNIT
163 ESTIMATION UNIT
164 DETERMINATION UNIT
165 PROPOSAL UNIT
166 DISPLAY CONTROL UNIT
200 SERVER DEVICE
210 COMMUNICATION UNIT
220 STORAGE UNIT
221 PRODUCT INFORMATION STORAGE UNIT
222 USER INFORMATION STORAGE UNIT
230 CONTROL UNIT
231 RECEIVING UNIT
232 TRANSMITTING UNIT
233 DETERMINATION UNIT
234 RECOGNITION UNIT

1. An information processing apparatus comprising:
a proposal unit that proposes, to a user, imaging of another real object that complements color information used for correcting a color gamut of a virtual object displayed to be superimposed on a predetermined real object; and
a display control unit that corrects the color gamut of the virtual object based on color information acquired by imaging of the another real object presented by the user.

2. The information processing apparatus according to claim 1,
wherein the proposal unit
proposes, to the user, imaging of the another real object selected from known objects of which color information is known.

3. The information processing apparatus according to claim 1,
wherein the proposal unit
proposes, to the user, imaging of the another real object selected based on a product purchase history of the user.

4. The information processing apparatus according to claim 3,
wherein the proposal unit
proposes, to the user, imaging of the another real object selected from products purchased by the user.

5. The information processing apparatus according to claim 3,
wherein the proposal unit
proposes, to the user, imaging of the another real object selected from a packaging container of a product purchased by the user.

6. The information processing apparatus according to claim 1,
wherein the proposal unit
proposes, to the user, imaging of the another real object selected based on an image captured by a terminal device of the user.

7. The information processing apparatus according to claim 6,
wherein the proposal unit
proposes, to the user, imaging of the another real object selected from objects included in the image captured by the terminal device of the user.

8. The information processing apparatus according to claim 1,
wherein the proposal unit
proposes, to the user, imaging of the another real object based on a comparison between color information regarding the predetermined real object and color information regarding the virtual object.

9. The information processing apparatus according to claim 1,
wherein, in a case where a distance in a color space between a color value of the predetermined real object and a color value of the virtual object exceeds a predetermined threshold, the proposal unit
proposes, to the user, imaging of the another real object.

10. The information processing apparatus according to claim 1,
wherein, in a case where an area, in a color space, of a region in which a color gamut of the predetermined real object and the color gamut of the virtual object overlap with each other is less than a predetermined threshold, the proposal unit
proposes, to the user, imaging of the another real object.

11. The information processing apparatus according to claim 1,
wherein the proposal unit
proposes, to the user, imaging of the another real object in which a distance in a color space between a color value of the another real object and a color value of the virtual object is smaller than a predetermined threshold with higher priority over the another real object in which the distance between the color value of the another real object and the color value of the virtual object is the predetermined threshold or more.

12. The information processing apparatus according to claim 1,
wherein the proposal unit
proposes, to the user, imaging of the another real object in which color information regarding the another real object does not exist in color information regarding the predetermined real object with higher priority over the another real object in which the color information regarding the another real object exists in the color information regarding the predetermined real object.

13. An information processing method in which a computer executes processing of:
proposing, to a user, imaging of another real object that complements color information used for correcting a color gamut of a virtual object displayed to be superimposed on a predetermined real object; and
correcting the color gamut of the virtual object based on color information acquired by imaging of the another real object presented by the user.

14. An information processing program for causing a computer to execute:
a proposal procedure of proposing, to a user, imaging of another real object that complements color information used for correcting a color gamut of a virtual object displayed to be superimposed on a predetermined real object; and
a display control procedure of correcting the color gamut of the virtual object based on color information acquired by imaging of the another real object presented by the user.
